(19) United States
(12) Patent Application Publication
(10) Pub. No.: US 2023/0062907 A1
(43) Pub. Date: Mar. 2, 2023

(54) BATTERY APPARATUS

(71) Applicant: MAKITA CORPORATION, ANJO-SHI (JP)

(72) Inventor: Hironori OGURA, Anjo-Shi (JP)

(21) Appl. No.: 17/794,730

(22) PCT Filed: Sep. 2, 2020
(86) PCT No.: PCT/JP2020/033298

§ 371 Date: Jul. 22, 2022

(30) Foreign Application Priority Data
Jan. 30, 2020 (JP) 2020-013201

(51) Int. Cl. H01M 50/233; H01M 10/42; H01M 50/213; H01M 50/247; H01M 50/258

(52) U.S. Cl. CPC H01M 50/233; H01M 10/4257; H01M 50/213; H01M 50/247; H01M 50/258; H01M 2220/30; H01M 2200/00

(57) ABSTRACT

A battery apparatus may include: one or more battery cells; one or more fire-extinguishing agents, which include(s) a component that provides a negative-catalyst effect with respect to combustion; and a casing, which houses the battery cell(s) and the fire-extinguishing agent(s). In the event that one or more of the battery cell(s) has (have) been subject to inappropriate handling and consequently has (have) ignited, the fire can be rapidly extinguished by the negative-catalyst effect of the fire-extinguishing agent(s). In addition, if one or more of the battery cell(s) of the battery apparatus has (have) ignited, because the fire can be rapidly extinguished, spreading of the fire to other battery cells, the casing, etc. can be inhibited.

### TECHNICAL FIELD

Techniques disclosed in the present specification relate to a battery apparatus.

### BACKGROUND ART

A battery apparatus that supplies electric power to an electric work machine is disclosed in the specification of U.S. Patent Application Publication No. 2015/0325826. With regard to the battery apparatus, a battery apparatus is disclosed that comprises: battery cells; fireproofing members, the volume of which swells in the event of burning of the battery cells; and a casing, which houses the battery cells and the fireproofing members.

### SUMMARY OF THE INVENTION

### Problems to be Solved by the Invention

With regard to the techniques in the specification of U.S. Patent Application Publication No. 2015/0325826, in the situation in which the battery cells have been subject to inappropriate handling and consequently have ignited, a certain amount of time is needed until the fire is extinguished by the fireproofing members. In the present specification, a technique is provided wherein, in the situation in which the battery cell(s) of the battery apparatus has (have) ignited, the fire can be rapidly extinguished.

### Means for Solving the Problems

The present specification discloses a battery apparatus that supplies electric power to an electric work machine. The battery apparatus may comprise: a battery cell or battery cells; a fire-extinguishing agent or fire-extinguishing agents, which include(s) a component that provides a negative-catalyst effect with respect to combustion; and a casing, which houses the battery cell(s) and the fire-extinguishing agent(s).

According to the above-mentioned configuration, in the event that the battery cell(s) has (have) been subject to inappropriate handling and consequently has (have) ignited, the fire can be rapidly extinguished by the negative-catalyst effect of the fire-extinguishing agent(s). In addition, according to the above-mentioned configuration, in the situation in which the battery cell(s) of the battery apparatus has (have) ignited, because the fire can be rapidly extinguished, spreading of the fire to other battery cells, the casing, etc. can be inhibited.

### BRIEF DESCRIPTION OF THE DRAWINGS

FIG. 1 is an oblique view of a backpack-type power supply 2 that comprises a battery apparatus 4 of Working Example 1.

FIG. 2 is an oblique view of the battery apparatus 4 of Working Example 1.

FIG. 3 is an oblique view of the state in which a rear-side casing 24 of the battery apparatus 4 of Working Example 1 has been removed.

FIG. 4 is an oblique view of the state in which the rear-side casing 24 and an inner cover 26 of the battery apparatus 4 of Working Example 1 have been removed.

FIG. 5 is an oblique view that shows the positional relationships between battery-cell modules 34, 36 and fire-extinguishing agents 40, 42, 44, 46, 48, 50, 52, 54 of the battery apparatus 4 of Working Example 1.

FIG. 6 is a partial, transverse, cross-sectional view of the battery apparatus 4 of Working Example 1.

FIG. 7 is an oblique view of a front-side casing 22 of the battery apparatus 4 of Working Example 1.

FIG. 8 is an oblique view of a modified example of the fire-extinguishing agents 40, 42, 44, 46, 48, 50, 52, 54 of Working Example 1.

FIG. 9 is a cross-sectional oblique view that shows the configuration of the interior of the battery apparatus 4 of Working Example 1.

FIG. 10 is an oblique view of a battery pack 102 of Working Example 2.

FIG. 11 is an exploded, oblique view of the battery pack 102 of Working Example 2.

FIG. 12 is an oblique view of a plurality of battery cells 122 of the battery pack 102 of Working Example 2.

FIG. 13 is an oblique view of the state in which the battery apparatus 4 of Working Example 1 is connected to an electric work machine 80.

### MODES FOR CARRYING OUT THE INVENTION

Representative and nonlimiting concrete examples of the present invention are explained in detail below, with reference to the drawings. This detailed description is merely intended to describe to a person skilled in the art details for implementing preferred embodiments of the present invention and is not intended to limit the scope of the present invention. In addition, the additional features and inventions disclosed below can be used separately and/or together with other features and inventions in order to provide a further improved battery apparatus, method of manufacturing the same, and method of using the same.

In addition, combinations of the features and processes disclosed in the detailed description below are, in the broadest meaning, not essential for implementing the present invention and are described merely to particularly explain representative concrete examples of the present invention. Furthermore, in the provision of additional and useful embodiments of the present invention, the various features of the representative concrete examples above and below and the various features recited in the independent and dependent claims do not have to be combined as in the concrete examples disclosed herein or in the order enumerated herein.

All features recited in the present specification and/or the claims are intended, separately from the configuration of features recited in the working examples and/or the claims, to be disclosed individually and mutually independently as limitations relative to specific matters disclosed in the disclosure and claims of the original patent application. Furthermore, description related to numerical ranges, groups, and collections are intended to disclose intermediate configurations thereof as limitations relative to specific matters recited in the disclosure and the claims of the original patent application.

In one or more embodiments, the battery apparatus may supply electric power to an electric work machine. The battery apparatus may comprise: a battery cell or battery cells; a fire-extinguishing agent or fire-extinguishing agent, which include(s) a component that provides a negative-catalyst effect with respect to combustion; and a casing, which houses the battery cell and the fire-extinguishing agent. It is noted that the negative-catalyst effect referred to in the present specification refers to the effect of inhibiting a combustion chain reaction. As the component that provides a negative-catalyst effect with respect to combustion, the fire-extinguishing agent(s) may be a component that absorbs combustion gases such as, for example, hydrogen, hydrogen sulfide, carbon monoxide, methane, ethane, propane, and ethylene. Alternatively, as the component that provides a negative-catalyst effect with respect to combustion, the fire-extinguishing agent(s) may be a component that inhibits the oxidation of inflammable substances by generating sodium chloride, sodium carbonate, sodium sulfate, or the like during combustion.

According to the above-mentioned configuration, in the event that the battery cell(s) has (have) been subject to inappropriate handling and consequently has ignited, the fire can be rapidly extinguished by the negative-catalyst effect of the fire-extinguishing agent(s). In addition, according to the above-mentioned configuration, in the situation in which the battery cell(s) of the battery apparatus have ignited, because the fire can be rapidly extinguished, spreading of the fire to other battery cells, the casing, etc. can be inhibited.

In one or more embodiments, the battery cell(s) of the battery apparatus may be charged to an SOC (state of charge) of 90% or more.

In the state in which the SOC of the battery cells is high, there is a risk that, in the event that the battery cell(s) has (have) ignited, the battery cell(s) will burn intensely. According to the above-mentioned configuration, in the event that the battery cell(s) has (have) been subject to inappropriate handling and consequently has (have) ignited, the inadvertent intense burning of the battery cell(s) can be inhibited.

In one or more embodiments, the energy density of the battery cell(s) may be 300 Wh/liter or more. For example, the energy density of the battery cell(s) may be 400 Wh/liter or more, may be 500 Wh/liter or more, may be 600 Wh/liter or more, or may be 700 Wh/liter or more.

When the energy density of the battery cell(s) is high, there is a risk that, in the event that the battery cell(s) has (have) ignited, the battery cell(s) will burn intensely. According to the above-mentioned configuration, in the event that the battery cell(s) has (have) been subject to inappropriate handling and consequently has (have) ignited, the inadvertent intense burning of the battery cell(s) can be inhibited.

In one or more embodiments, the battery apparatus may comprise a protective member or protective members, which cover(s) at least a portion of the fire-extinguishing agent(s).

According to the above-mentioned configuration, even in the situation in which an impact is imparted to the battery apparatus, the fire-extinguishing agent(s) can be protected.

In one or more embodiments, the battery cells may comprise five or more cylindrical-type battery cells. For example, the battery cells may comprise 10 or more cylindrical-type battery cells, may comprise 20 or more cylindrical-type battery cells, may comprise 50 or more cylindrical-type battery cells, or may comprise 100 or more cylindrical-type battery cells.

In the situation in which the battery cells comprise numerous cylindrical-type battery cells, the risk that any of the cylindrical-type battery cells will ignite becomes higher than the situation in which the battery cells comprise a small number of cylindrical-type battery cells. According to the above-mentioned configuration, in the event that any of the cylindrical-type battery cells has ignited, the fire can be rapidly extinguished.

In one or more embodiments, the casing may have a chamber, which houses the battery cell(s) and the fire-extinguishing agent(s). The chamber may be sealed.

According to the above-mentioned configuration, in the event that the battery cell(s) has (have) ignited, leakage of the component(s) of the fire-extinguishing agent(s) to the exterior of the chamber can be curtailed. In the event that the battery cell(s) has (have) been subject to inappropriate handling and consequently has (have) ignited, the fire can be rapidly extinguished.

In one or more embodiments, the fire-extinguishing agent(s) may comprise a first fire-extinguishing agent, which is disposed opposing the electrode(s) of the battery cell(s).

In the event that the battery cell(s) has (have) ignited, it is often the case that flames extend from the electrode(s). According to the above-mentioned configuration, in the event that the battery cell(s) has (have) ignited, the first fire-extinguishing agent becomes easily exposed to the flames and thereby can rapidly exhibit the negative-catalyst effect. In the event that the battery cell(s) has (have) been subject to inappropriate handling and consequently has (have) ignited, the fire can be rapidly extinguished.

In one or more embodiments, the first fire-extinguishing agent(s) may be disposed opposing the positive electrode(s) of the battery cell(s).

With regard to a specific type of battery cell, in the event that the battery cell(s) ignite(s), flames extend from the positive electrode(s). According to the above-mentioned configuration, in the event that the battery cell(s) of such a type has (have) ignited, the first fire-extinguishing agent becomes easily exposed to the flames and thereby can rapidly exhibit the negative-catalyst effect. In the event that the battery cell(s) has (have) been subject to inappropriate handling and consequently has (have) ignited, the fire can be rapidly extinguished.

In one or more embodiments, the battery apparatus may further comprise: a cell holder or cell holders, which is (are) housed in the casing and hold(s) the battery cell(s); and a circuit board, which is housed in the casing and is mounted on the cell holder(s). The fire-extinguishing agent(s) may comprise a second fire-extinguishing agent, which is disposed between the circuit board and the cell holder(s).

According to the above-mentioned configuration, space between the cell holder(s) and the circuit board can be effectively utilized.

In one or more embodiments, the battery cell(s) may be a lithium-ion battery cell or battery cells.

The risk that a lithium-ion battery cell will ignite, owing to a variety of causes, is higher than in other types of battery cells. According to the above-mentioned configuration, even in the situation in which the lithium-ion battery cell(s) has (have) been subject to inappropriate handling and consequently has (have) ignited, the fire can be rapidly extinguished.

### WORKING EXAMPLE 1

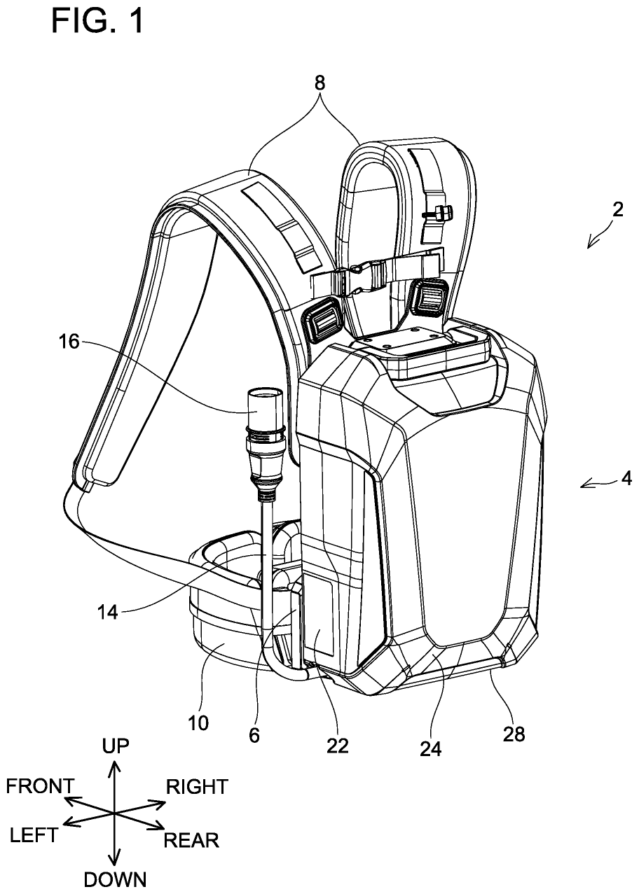

As shown in FIG. 1, a backpack-type power supply 2 of the present working example comprises: a battery apparatus 4; a backpack frame 6, which supports the battery apparatus 4; shoulder belts 8, which are attached to the backpack frame 6; and a hip belt 10, which is attached to the backpack frame 6. A user slings the shoulder belts 8 over the shoulders and straps the hip belt 10 around the hip, and thereby can hold the backpack-type power supply 2 in the state in which the backpack-type power supply 2 is carried on the back. It is noted that, in the explanation below, in the state in which the user carries the backpack-type power supply 2 on the back, an up-down direction, a left-right direction, and a front-rear direction, when viewed from the user, refer to the up-down direction, the left-right direction, and the front-rear direction, respectively, of the backpack-type power supply 2.

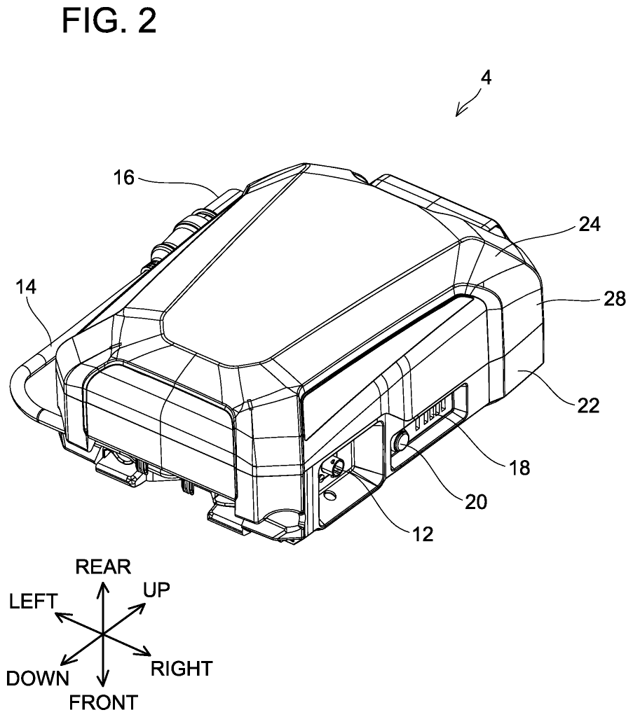

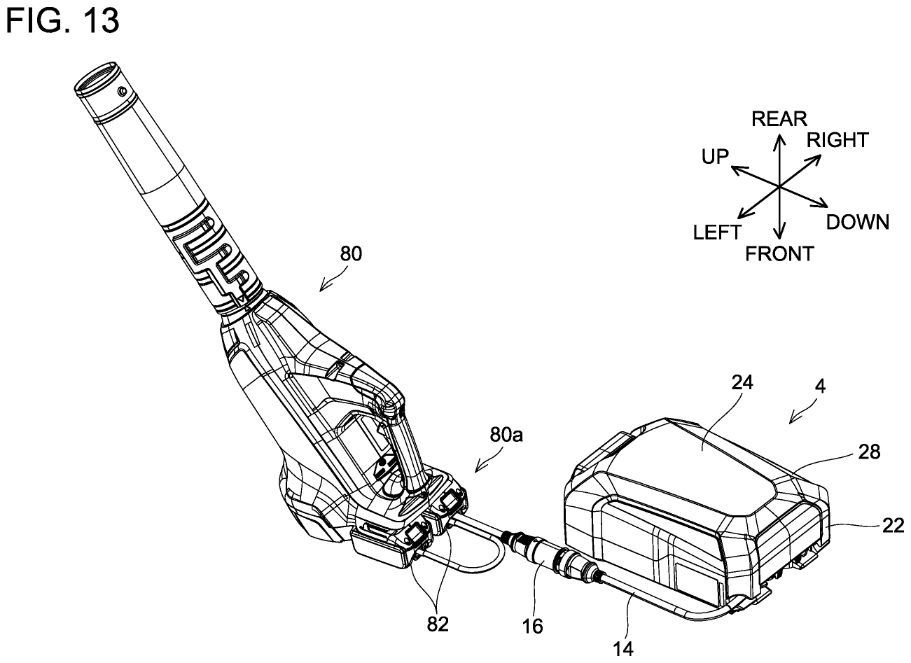

As shown in FIG. 2, the battery apparatus 4 comprises a charging plug 12, a discharging cable 14, a discharging plug 16, remaining-charge indication lamps 18, and a remaining-charge indication button 20. The discharging plug 16 is provided on (at) a tip of the discharging cable 14. By connecting the charging plug 12 to an external power supply (not shown) via a charging cable (not shown), the battery apparatus 4 can be charged by an external power supply. In addition, as shown in FIG. 13, by connecting the battery apparatus 4 to an electric work machine 80 via the discharging cable 14, the battery apparatus 4 can discharge to the electric work machine 80. In the example shown in FIG. 13, the electric work machine 80 is a blower in which a battery pack or battery packs (not shown) can be mounted on and demounted from a battery-pack mount part 80a or battery-pack mount parts 80a. In the example shown in FIG. 13, adapters 82 instead of battery packs are mounted on the battery-pack mount parts 80a of the electric work machine 80, and the discharging plug 16 is connected to the adapters 82. It is noted that the electric work machine 80 may be configured such that it is directly connectable to the discharging plug 16 without the adapters 82 intervening therebetween. In addition, the electric work machine 80 may be some other electric work machine such as, for example, a mowing machine, a chain saw, or the like, or may be a so-called power tool such as a driver, a drill, or the like. The remaining-charge indication lamps 18 display the amount of charge remaining in the battery apparatus 4. The remaining-charge indication button 20 switches the battery-remaining charge indication of the remaining-charge indication lamps 18 ON and OFF.

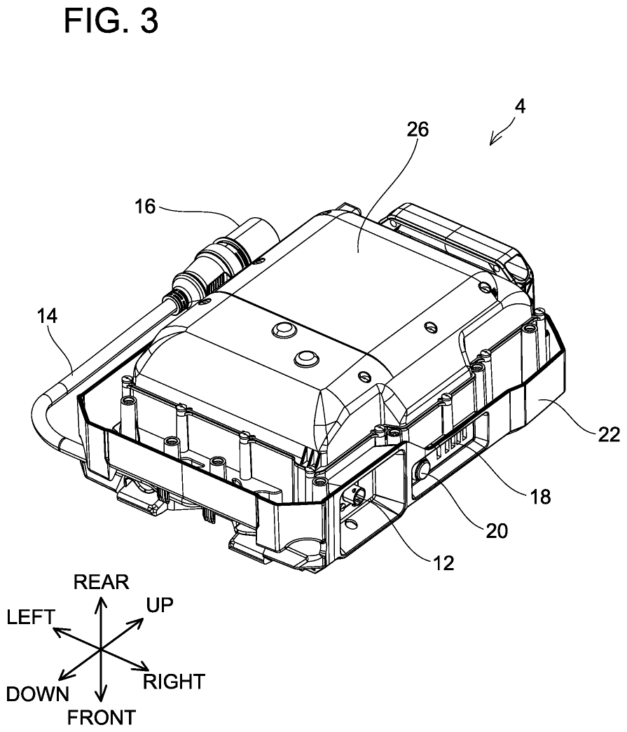

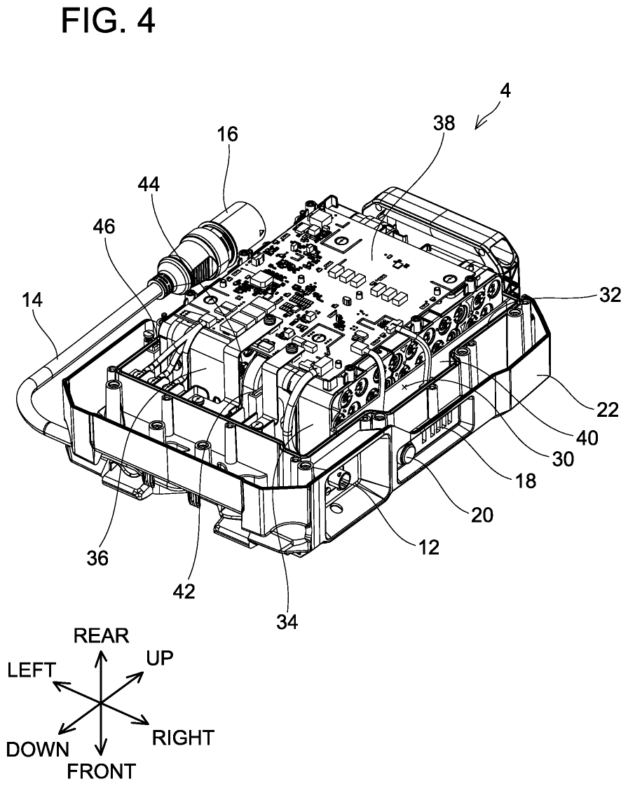

As shown in FIG. 2, FIG. 3, and FIG. 4, the battery apparatus 4 comprises a front-side casing 22, a rear-side casing 24, and an inner cover 26. It is noted that, hereinbelow, the front-side casing 22, the rear-side casing 24, and the inner cover 26 are also collectively referred to simply as a casing 28. The rear-side casing 24 and the inner cover 26 are each fixed to the front-side casing 22 by a fastener. Hereinbelow, the space enclosed by the front-side casing 22 and the inner cover 26 is also referred to as a chamber 30. A sealing member 32 is provided along the connection location between the front-side casing 22 and the inner cover 26. The chamber 30 is sealed from the exterior by the sealing member 32.

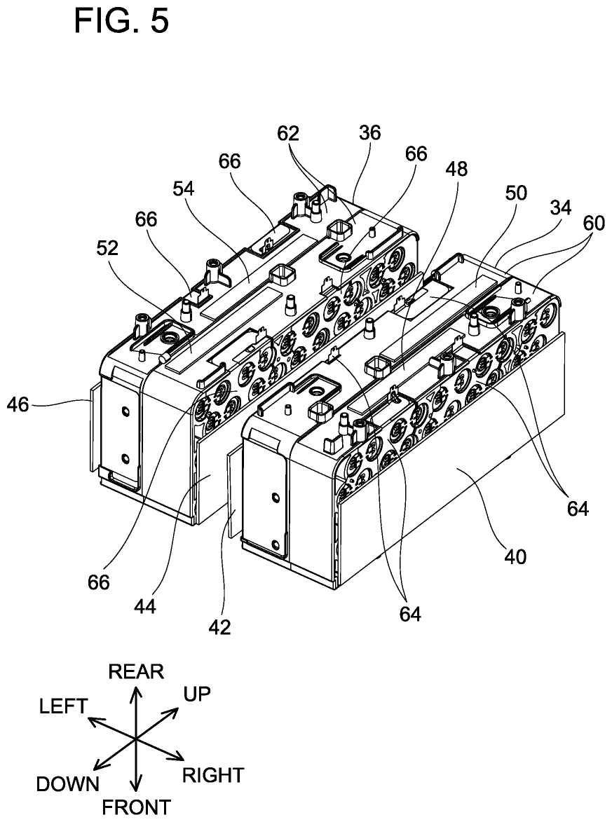

As shown in FIG. 4 and FIG. 5, battery-cell modules 34, 36, a control circuit board 38, and fire-extinguishing agents 40, 42, 44, 46, 48, 50, 52, 54 are housed in the chamber 30. Each of the battery-cell modules 34, 36 is fixed to the front-side casing 22 by fasteners. The control circuit board 38 is fixed to the battery-cell modules 34, 36 by fasteners.

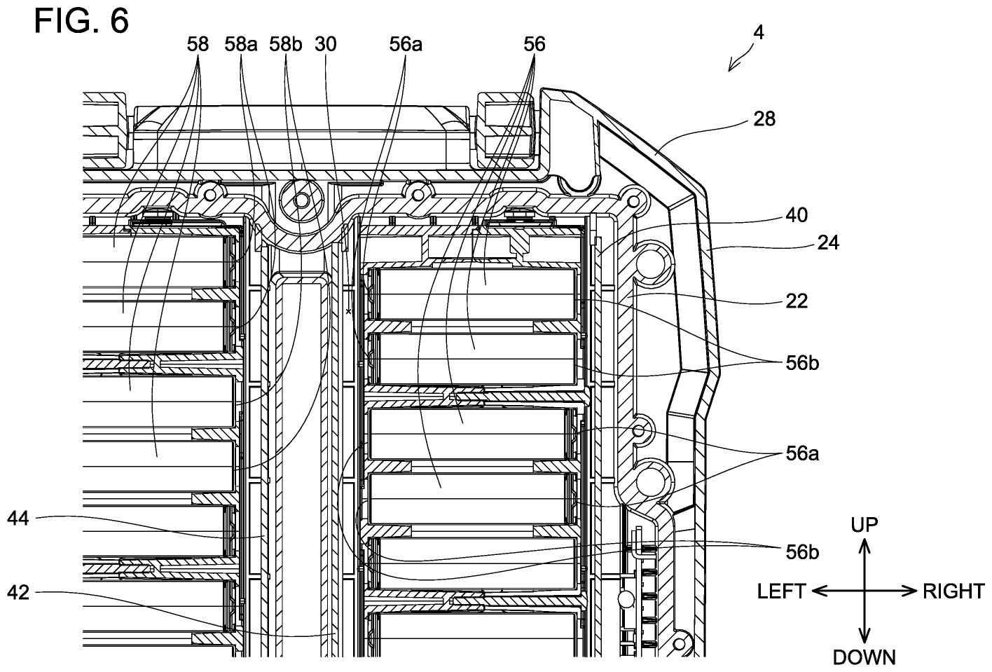

As shown in FIG. 5 and FIG. 6, the battery-cell modules 34, 36 respectively comprise: a plurality of battery cells 56, 58; cell holders 60, 62, which hold the plurality of battery cells 56, 58; and lead plates 64, 66, which electrically connect the plurality of battery cells 56, 58 to the control circuit board 38. Each battery cell of the plurality of battery cells 56, 58 is a secondary-battery cell having, for example, a substantially cylindrical shape, and is, for example, a lithium-ion battery cell. Each of the battery cells 56, 58 has, for example, the shape of an 18650-type cell, a volumetric-energy density of 729 Wh/liter, a rated capacity of 3.35 Ah, and a rated voltage of 3.6 V. It is noted that each of the battery cells 56, 58 may have a volumetric-energy density of 327 Wh/liter or may have a rated capacity of 1.5 Ah. Alternatively, each of the battery cells 56, 58 may have a volumetric-energy density of 436 Wh/liter or may have a rated capacity of 2 Ah. Alternatively, each of the battery cells 56, 58 may have a volumetric-energy density of 544 Wh/liter or may have a rated capacity of 2.5 Ah. Alternatively, each of the battery cells 56, 58 may have a volumetric-energy density of 653 Wh/liter or may have a rated capacity of 3 Ah. Alternatively, each of the battery cells 56, 58 may have the shape of a 21700-type cell, may have a volumetric-energy density of 594 Wh/liter, may have a rated capacity of 4 Ah, or may have a rated voltage of 3.6 V. It is noted that each of the battery cells 56, 58 is not limited to having a substantially cylindrical shape and may be a so-called rectangular-prism type or may be a laminate type. With regard to the battery apparatus 4, each of the battery cells 56, 58 is charged to an SOC (state of charge) of 90% or more. The plurality of battery cells 56, 58 respectively comprise positive electrodes 56a, 58a and negative electrodes 56b, 58b, which serve as electrodes. The battery cells 56, 58 are disposed lined up in the front-rear direction and the up-down direction such that their longitudinal direction is aligned in the left-right direction. In the present working example, the battery-cell module 34 comprises a total of 50 of the battery cells 56, with 10 across in the up-down direction and five across in the front-rear direction, and the battery-cell module 36 comprises a total of 50 of the battery cells 58, with 10 across in the up-down direction and five across in the front-rear direction. With regard to some of the battery cells 56, 58, the positive electrodes 56a, 58a are disposed on the right side and the negative electrodes 56b, 58b are disposed on the left side; with regard to the remainder of the battery cells 56, 58, the positive electrodes 56a, 58a are disposed on the left side and the negative electrodes 56b, 58b are disposed on the right side. The lead plates 64 are provided on the right surface and the left surface of the battery-cell module 34, and each of the positive electrodes 56a and each of the negative electrodes 56b of the battery cells 56 are electrically connected to the control circuit board 38, which is fixed to the cell holders 60. The lead plates 66 are provided on the right surface and the left surface of the battery-cell module 36, and each of the positive electrodes 58a and each of the negative electrodes 58b of the battery cells 58 are electrically connected to the control circuit board 38, which is fixed to the cell holders 62.

The fire-extinguishing agents 40, 42, 44, 46, 48, 50, 52, 54 include a component that provides a negative-catalyst effect with respect to combustion. For example, the fire-extinguishing agents 40, 42, 44, 46, 48, 50, 52, 54 may be formed by compressing a solid powder-like fire-extinguishing agent into a plate shape or by sealing a gaseous or liquid fire-extinguishing agent within a plate-shaped thin-film container. As components that provide a negative-catalyst effect with respect to combustion, the fire-extinguishing agents 40, 42, 44, 46, 48, 50, 52, 54 may include components that absorb combustion gases such as, for example, hydrogen, hydrogen sulfide, carbon monoxide, methane, ethane, propane, and ethylene. Alternatively, as components that provide a negative-catalyst effect with respect to combustion, the fire-extinguishing agents 40, 42, 44, 46, 48, 50, 52, 54 may include components that inhibit the oxidation of flammable substances by generating sodium chloride, sodium carbonate, sodium sulfate, or the like during combustion.

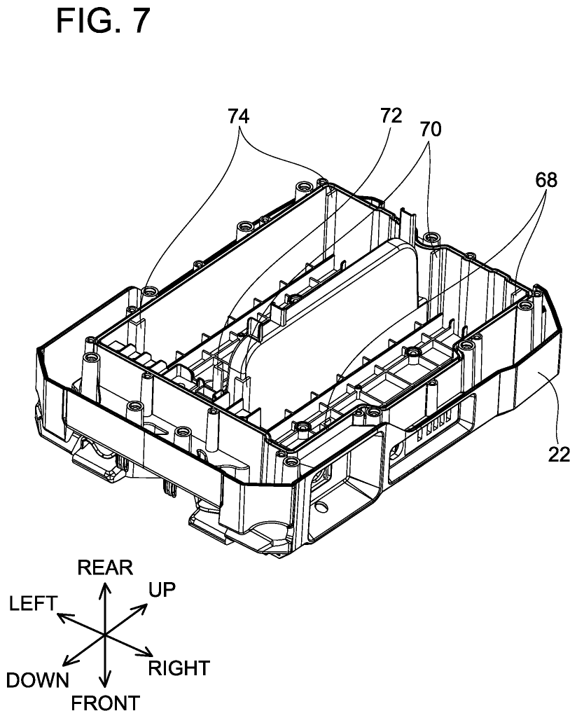

As shown in FIG. 7, slots 68, 70, 72, 74, which are for holding the fire-extinguishing agents 40, 42, 44, 46, are formed in the front-side casing 22. The fire-extinguishing agent 40 is held by the slots 68 on the right side of the battery-cell module 34. The fire-extinguishing agent 42 is held by the slots 70 on the left side of the battery-cell module 34. The fire-extinguishing agent 44 is held by the slots 72 on the right side of the battery-cell module 36. The fire-extinguishing agent 46 is held by the slots 74 on the left side of the battery-cell module 36. Consequently, as shown in FIG. 5, the fire-extinguishing agents 40, 42 are disposed opposing the positive electrodes 56a and the negative electrodes 56b of the plurality of battery cells 56, and the fire-extinguishing agents 44, 46 are disposed opposing the positive electrodes 58a and the negative electrodes 58b of the plurality of battery cells 58. It is noted that, in the situation in which the slots 68, 70, 72, 74 are not formed in the front-side casing 22, the fire-extinguishing agents 40, 42, 44, 46 may be adhered to the battery-cell modules 34, 36 by adhesive tape.

The fire-extinguishing agents 48, 50 are adhered to the rear surfaces of the cell holders 60 of the battery-cell module 34. The fire-extinguishing agents 52, 54 are adhered to the rear surfaces of the cell holders 62 of the battery-cell module 36. In the state in which the control circuit board 38 is mounted on the cell holders 60, 62, the fire-extinguishing agents 48, 50 are disposed between the control circuit board 38 and the cell holders 60, and the fire-extinguishing agents 52, 54 are disposed between the control circuit board 38 and the cell holders 62.

There are situations in which, owing to inappropriate handling of the battery apparatus 4, the battery cell(s) 56, 58 may ignite and consequently flames may be emitted from the positive electrode(s) 56a, 58a. In such situations, with regard to the battery apparatus 4 of the present working example, flames from the battery cell(s) 56, 58 will be extinguished by the negative-catalyst effect of the fire-extinguishing agents 40, 42, 44, 46, 48, 50, 52, 54. According to the battery apparatus 4 of the present working example, even in the situation in which the battery cell(s) 56, 58 has (have) ignited, it (they) can be rapidly extinguished. In addition, with regard to the battery apparatus 4 of the present working example, because the chamber 30, which houses the battery cells 56, 58 and the fire-extinguishing agents 40, 42, 44, 46, 48, 50, 52, 54, is sealed, in the situation in which the battery cell(s) 56, 58 has (have) ignited, it is possible to inhibit the leakage of component(s) of the fire-extinguishing agents 40, 42, 44, 46, 48, 50, 52, 54 out to the exterior of the chamber 30. The flames of the battery cell(s) 56, 58 can be rapidly extinguished.

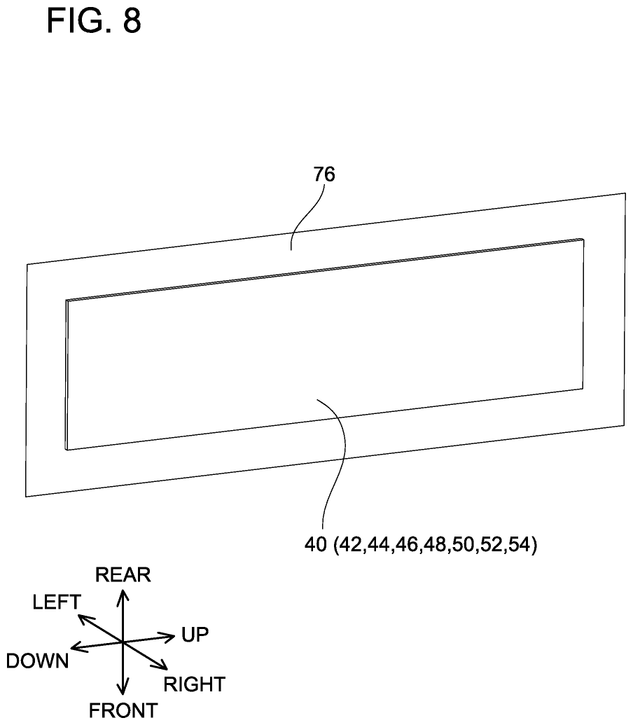

It is noted that, as shown in FIG. 8, a front surface and a rear surface of each of the fire-extinguishing agents 40, 42, 44, 46, 48, 52, 54 may be covered by laminate films 76. In this situation, the fire-extinguishing agents 40, 42, 44, 46, 48, 52, 54 can be protected and the handleability of the fire-extinguishing agents 40, 42, 44, 46, 48, 52, 54 when manufacturing the battery apparatus 4 can be improved. It is noted that, in the situation in which the laminate films 76 have stiffness and strength to a certain extent, the laminate films 76 may be fixed to a right surface, a left surface, and a rear surface of each of the cell holders 60, 62 by fasteners. In this situation as well, the fire-extinguishing agents 40, 42, 44, 46 can be disposed opposing the positive electrodes 56a, 58a and the negative electrodes 56b, 58b of the plurality of battery cells 56, 58, and the fire-extinguishing agents 48, 50, 52, 54 can be disposed between the control circuit board 38 and the cell holders 60, 62.

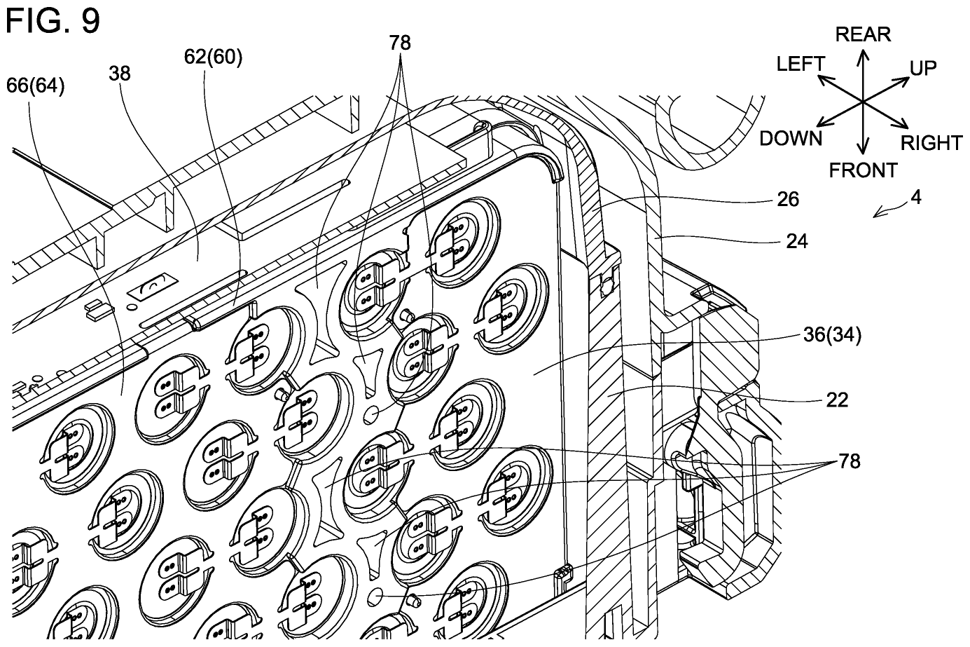

In the above-mentioned working example, fire-extinguishing agents of other shapes may be used instead of the plate-shaped fire-extinguishing agents 40, 42, 44, 46, 48, 52, 54. For example, as shown in FIG. 9, in the situation in which the cell holders 60, 62 have various hollows 78, fire-extinguishing agents (not shown), which have been formed by compressing a solid powder to conform to the shape of the hollows 78, may be filled into the hollows 78.

As described above, in one or more embodiments, the battery apparatus 4 supplies electric power to the electric work machine 80. The battery apparatus 4 comprises: the battery cells 56, 58; the fire-extinguishing agents 40, 42, 44, 46, 48, 50, 52, 54, which include a component that provides a negative-catalyst effect with respect to combustion; and the casing 28, which houses the battery cells 56, 58 and the fire-extinguishing agents 40, 42, 44, 46, 48, 50, 52, 54.

According to the above-mentioned configuration, in the event that the battery cell(s) 56, 58 has (have) been subject to inappropriate handling and consequently has (have) ignited, the fire can be rapidly extinguished by the negative-catalyst effect of the fire-extinguishing agents 40, 42, 44, 46, 48, 50, 52, 54. In addition, according to the above-mentioned configuration, in the situation in which the battery cell(s) 56, 58 of the battery apparatus 4 has (have) ignited, because the fire can be rapidly extinguished, spreading of the fire to the other battery cells 56, 58, the casing 28, etc. can be inhibited.

In one or more embodiments, the battery cells 56, 58 of the battery apparatus 4 are charged to an SOC (state of charge) of 90% or more.

In the state in which the SOC of the battery cells 56, 58 is high, there is a risk that, in the event that the battery cell(s) 56, 58 has (have) ignited, the battery cell(s) 56, 58 will burn intensely. According to the above-mentioned configuration, in the event that the battery cell(s) 56, 58 has (have) been subject to inappropriate handling and consequently has (have) ignited, the inadvertent intense burning of the battery cell(s) 56, 58 can be inhibited.

In one or more embodiments, the energy density of the battery cells 56, 58 is 300 Wh/liter or more.

When the energy density of the battery cells 56, 58 is high, there is a risk that, in the event that the battery cell(s) 56, 58 has (have) ignited, the battery cell(s) 56, 58 will burn intensely. According to the above-mentioned configuration, in the event that the battery cell(s) 56, 58 have been subject to inappropriate handling and consequently has (have) ignited, the inadvertent intense burning of the battery cell(s) 56, 58 can be inhibited.

In one or more embodiments, the battery apparatus 4 comprises the laminate films 76 (example of protective member), which cover at least a portion of each of the fire-extinguishing agents 40, 42, 44, 46, 48, 50, 52, 54.

According to the above-mentioned configuration, even in the situation in which an impact is imparted to the battery apparatus 4, the fire-extinguishing agents 40, 42, 44, 46, 48, 50, 52, 54 can be protected.

In one or more embodiments, the battery cells 56, 58 comprise five or more cylindrical-type battery cells.

In the situation in which the battery cells 56, 58 comprise numerous cylindrical-type battery cells, the risk that any of the cylindrical-type battery cells will ignite becomes higher than the situation in which the battery cells comprise a small number of cylindrical-type battery cells. According to the above-mentioned configuration, in the event that any of the cylindrical-type battery cells has ignited, the fire can be rapidly extinguished.

In one or more embodiments, the casing 28 has a chamber 30, which houses the battery cells 56, 58 and the fire-extinguishing agents 40, 42, 44, 46, 48, 50, 52, 54. The chamber 30 is sealed.

According to the above-mentioned configuration, in the event that the battery cell(s) 56, 58 has (have) ignited, leakage of the component(s) of the fire-extinguishing agents 40, 42, 44, 46, 48, 50, 52, 54 to the exterior of the chamber 30 can be curtailed. In the event that the battery cell(s) 56, 58 has (have) been subject to inappropriate handling and consequently has (have) ignited, the fire can be rapidly extinguished.

In one or more embodiments, the fire-extinguishing agents 40, 42, 44, 46, 48, 50, 52, 54 comprise the fire-extinguishing agents 40, 42, 44, 46 (examples of a first fire-extinguishing agent), which are disposed opposing the positive electrodes 56a, 58a and the negative electrodes 56b, 58b (examples of an electrode) of the battery cells 56, 58.

In the event that the battery cell(s) 56, 58 has (have) ignited, it is often the case that the flames extend from the positive electrode(s) 56a, 58a and the negative electrode(s) 56b, 58b. According to the above-mentioned configuration, in the event that the battery cell(s) 56, 58 has (have) ignited, the fire-extinguishing agents 40, 42, 44, 46 become easily exposed to the flames and thereby can rapidly exhibit the negative-catalyst effect. In the event that the battery cell(s) 56, 58 has (have) been subject to inappropriate handling and consequently has (have) ignited, the fire can be rapidly extinguished.

In one or more embodiments, the fire-extinguishing agents 40, 42, 44, 46 are disposed opposing the positive electrodes 56a, 58a of the battery cells 56, 58.

With regard to the specific type of battery cells 56, 58 (for example, lithium-ion battery cells), in the event that the battery cell(s) 56, 58 ignite(s), flames extend from the positive electrode(s) 56a, 58a. According to the above-mentioned configuration, in the event that the battery cell(s) 56, 58 of such a type have ignited, the fire-extinguishing agents 40, 42, 44, 46 become easily exposed to the flames and thereby can rapidly exhibit the negative-catalyst effect. In the event that the battery cell(s) 56, 58 has (have) been subject to inappropriate handling and consequently has (have) ignited, the fire can be rapidly extinguished.

In one or more embodiments, the battery apparatus 4 further comprises: the cell holders 60, 62, which are housed in the casing 28 and hold the battery cells 56, 58; and the control circuit board 38 (example of a circuit board), which is housed in the casing 28 and is mounted on the cell holders 60, 62. The fire-extinguishing agents 40, 42, 44, 46, 48, 50, 52, 54 comprise the fire-extinguishing agents 48, 50, 52, 54 (examples of a second fire-extinguishing agent), which are disposed between the control circuit board 38 and the cell holders 60, 62.

According to the above-mentioned configuration, the space between the cell holders 60, 62 and the control circuit board 38 can be effectively utilized.

In one or more embodiments, the battery cells 56, 58 are lithium-ion battery cells.

The risk that a lithium-ion battery cell will ignite, owing to a variety of causes, is higher than in other types of battery cells. According to the above-mentioned configuration, even in the situation in which the lithium-ion battery cell(s) has (have) ignited, the fire can be rapidly extinguished.

### WORKING EXAMPLE 2

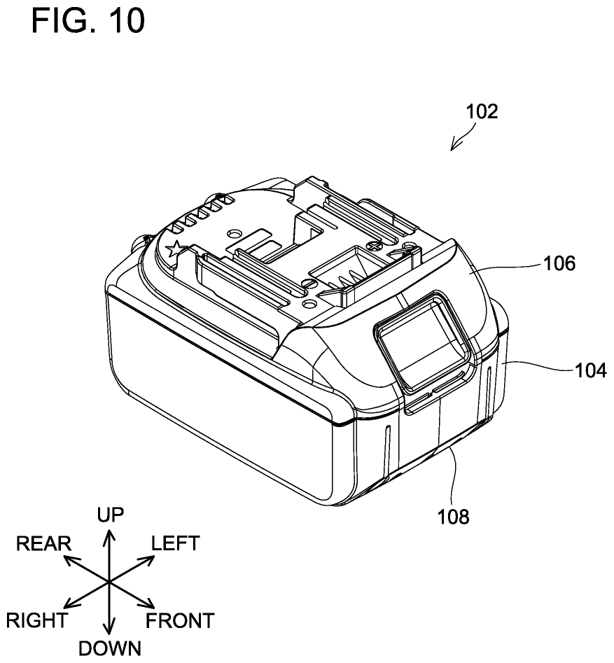

A battery pack 102 of the present working example, which is shown in FIG. 10, is used by being mounted on a battery-pack mount part 80a of the electric work machine 80 (refer to FIG. 13). The electric work machine 80 may be a blower as shown in FIG. 13, may be some other electric work machine such as a mowing machine or a chain saw, or may be a so-called power tool such as a driver or a drill. The battery pack 102 can be mounted on and demounted from the electric work machine 80 by being slid in a prescribed sliding direction relative to the electric work machine 80. Hereinbelow, the direction in which the battery pack 102 is slid when the battery pack 102 is being mounted on the electric work machine 80 is called the rearward direction, and the direction in which the battery pack 102 is slid when the battery pack 102 is being removed from the electric work machine 80 is called the rearward direction. In addition, in the state in which the battery pack 102 is mounted on the electric work machine 80, the direction, viewed from the battery pack 102, in which the electric work machine 80 is located is called the upward direction, and the direction the reverse of the upward direction is called the downward direction. Furthermore, the direction orthogonal to the front-rear direction and the up-down direction is called the left-right direction.

As shown in FIG. 10, the battery pack 102 comprises a lower-side casing 104 and an upper-side casing 106. It is noted that, hereinbelow, the lower-side casing 104 and the upper-side casing 106 are collectively also called simply a casing 108. The upper-side casing 106 is fixed to the lower-side casing 104 by a fastener or fasteners.

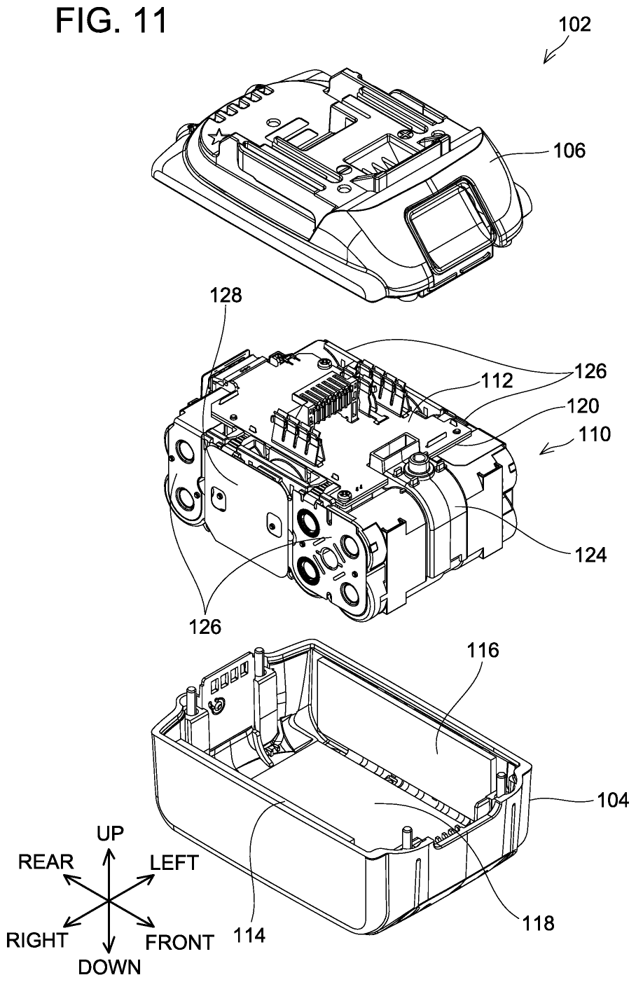

As shown in FIG. 11, a battery-cell module 110, a control circuit board 112, and fire-extinguishing agents 114, 116, 118, 120 are housed in the interior of the casing 108. The battery-cell module 110 is mounted in the interior of the lower-side casing 104. The control circuit board 112 is fixed to the battery-cell module 110 by fasteners.

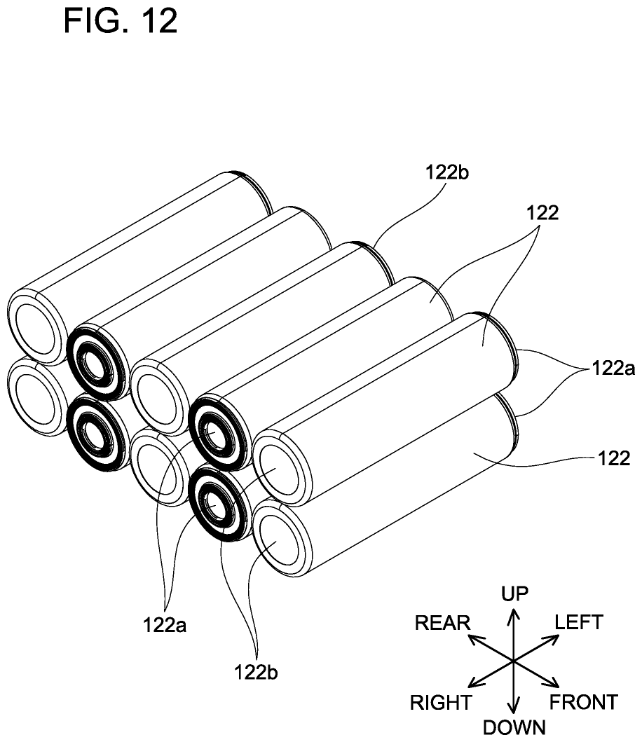

The battery-cell module 110 comprises: a plurality of battery cells 122 (refer to FIG. 12); a cell holder 124, which holds the plurality of battery cells 122; lead plates 126, which electrically connect the plurality of battery cells 122 to the control circuit board 112; and insulating sheets 128, which insulate the lead plates 126 that are adjacent to one another. Each of the battery cells 122 is a secondary-battery cell having, for example, a substantially cylindrical shape, and is, for example, a lithium-ion battery cell. Each of the battery cells 122 has, for example, the shape of an 18650-type cell, a volumetric-energy density of 653 Wh/liter, a rated capacity of 3 Ah, and a rated voltage of 3.6 V. It is noted that each of the battery cells 122 may have a volumetric-energy density of 327 Wh/liter or may have a rated capacity of 1.5 Ah. Alternatively, each of the battery cells 122 may have a volumetric-energy density of 436 Wh/liter or may have a rated capacity of 2 Ah. Alternatively, each of the battery cells 122 may have a volumetric-energy density of 544 Wh/liter or may have a rated capacity of 2.5 Ah. Alternatively, each of the battery cells 122 may have a volumetric-energy density of 653 Wh/liter or may have a rated capacity of 3 Ah. Alternatively, each of the battery cells 122 may have the shape of a 21700-type cell, may have a volumetric-energy density of 594 Wh/liter, may have a rated capacity of 4 Ah, or may have a rated voltage of 3.6 V. It is noted that each of the battery cells 122 is not limited to having a substantially cylindrical shape and may be a so-called rectangular-prism type or may be a laminate type. With regard to the battery pack 202, each of the battery cells 122 is charged to an SOC (state of charge) of 90% or more. As shown in FIG. 12, each of the battery cells 122 comprises a positive electrode 122a and a negative electrode 122b, which serve as electrodes. The battery cells 122 are disposed lined up in the front-rear direction and the up-down direction such that their longitudinal directions are aligned in the left-right direction. In the present working example, the battery-cell module 110 comprises a total of 10 of the battery cells 122, with two across in the up-down direction and five across in the front-rear direction. With regard to some of the battery cells 122, the positive electrodes 122a are disposed on the right side and the negative electrodes 122b are disposed on the left side; with regard to the remainder of the battery cells 122, the positive electrodes 122a are disposed on the left side and the negative electrodes 122b are disposed on the right side. The lead plates 126 are provided on the right surface and the left surface of the battery-cell module 110, and each of the positive electrodes 122a and each of the negative electrodes 122b of the battery cells 122 are electrically connected to the control circuit board 112, which is fixed to the cell holder 124. The insulating sheets 128 are adhered to portions of the lead plates 126; in the situation in which an electrically conductive substance, such as water, has penetrated into the interior of the casing, the occurrence of an electrical short between the lead plates 126 that are adjacent to one another can be prevented.

The fire-extinguishing agents 114, 116, 118, 120 are the same as the fire-extinguishing agents 40, 42, 44, 46, 48, 50, 52, 54 of Working Example 1. The fire-extinguishing agent 114 is disposed between a right-side surface on the inner side of the lower-side casing 104 and a right surface of the battery-cell module 110. The fire-extinguishing agent 116 is disposed between a left-side surface on the inner side of the lower-side casing 104 and a left surface of the battery-cell module 110. Consequently, the fire-extinguishing agents 114, 116 are disposed opposing the positive electrodes 122a and the negative electrodes 122b of the plurality of battery cells 122. In addition, the fire-extinguishing agent 118 is disposed between a bottom surface on the inner side of the lower-side casing 104 and a lower surface of the battery-cell module 110. The fire-extinguishing agent 120 is disposed between the control circuit board 112 and the cell holder 124.

There are situations in which, owing to inappropriate handling of the battery pack 102, the battery cell(s) 122 may ignite and consequently flames may be emitted from the positive electrode(s) 122a. In such situations, with regard to the battery pack 102 of the present working example, flames from the battery cell(s) 122 are extinguished owing to the negative-catalyst effect of the fire-extinguishing agents 114, 116, 118, 120. According to the battery pack 102 of the present working example, even in the situation in which the battery cell(s) 122 has (have) ignited, it (they) can be rapidly extinguished.

It is noted that the fire-extinguishing agents 114, 116, 118, 120 of the present working example are likewise the same as the fire-extinguishing agents 40, 42, 44, 46, 48, 50, 52, 54 of Working Example 1, and the front surface and the rear surface of each of the fire-extinguishing agents 114, 116, 118, 120 may be covered by the laminate films 76.

As described above, in one or more embodiments, the battery pack 102 (example of a battery apparatus) supplies electric power to the electric work machine 80. The battery pack 102 comprises: the battery cells 122; the fire-extinguishing agents 114, 116, 118, 120, which include a component that provides a negative-catalyst effect with respect to combustion; and the casing 108, which houses the battery cells 122 and the fire-extinguishing agents 114, 116, 118, 120.

According to the above-mentioned configuration, in the event that the battery cell(s) 122 has (have) been subject to inappropriate handling and consequently has (have) ignited, the fire can be rapidly extinguished by the negative-catalyst effect of the fire-extinguishing agents 114, 116, 118, 120. In addition, according to the above-mentioned configuration, in the situation in which the battery cell(s) 122 of the battery pack 102 has (have) ignited, because the fire can be rapidly extinguished, spreading of the fire to the other battery cells 122, the casing 108, etc. can be inhibited.

In one or more embodiments, the battery cells 122 of the battery pack 102 are charged to an SOC (state of charge) of 90% or more.

In the state in which the SOC of the battery cells 122 is high, there is a risk that, in the event that the battery cell(s) 122 has (have) ignited, the battery cell(s) 122 will burn intensely. According to the above-mentioned configuration, in the event that the battery cell(s) 122 has (have) been subject to inappropriate handling and consequently has (have) ignited, the inadvertent intense burning of the battery cell(s) 122 can be inhibited.

In one or more embodiments, the energy density of the battery cells 122 is 300 Wh/liter or more.

When the energy density of the battery cells 122 is high, there is a risk that, in the event that the battery cell(s) 122 has (have) ignited, the battery cell(s) 122 will burn intensely. According to the above-mentioned configuration, in the event that the battery cell(s) 122 has (have) been subject to inappropriate handling and consequently has (have) ignited, the inadvertent intense burning of the battery cell(s) 122 can be inhibited.

In one or more embodiments, the battery pack 102 comprises the laminate films 76 (example of protective member), which cover at least a portion of each of the fire-extinguishing agents 114, 116, 118, 120.

According to the above-mentioned configuration, even in the situation in which an impact is imparted to the battery pack 102, the fire-extinguishing agents 114, 116, 118, 120 can be protected.

In one or more embodiments, the battery cells 122 comprise five or more cylindrical-type battery cells.

In the situation in which the battery cells 122 comprise numerous cylindrical-type battery cells, the risk that any of the cylindrical-type battery cells will ignite becomes higher than the situation in which the battery cells comprise a small number of cylindrical-type battery cells. According to the above-mentioned configuration, in the event that any of the cylindrical-type battery cells has ignited, the fire can be rapidly extinguished.

In one or more embodiments, the fire-extinguishing agents 114, 116, 118, 120 comprise the fire-extinguishing agents 114, 116 (examples of a first fire-extinguishing agent), which are disposed opposing the positive electrodes 122a and the negative electrodes 122b (examples of an electrode) of the battery cells 122.

In the event that the battery cell(s) 122 has (have) ignited, it is often the case that the flames extend from the positive electrode(s) 122a and the negative electrode(s) 122b. According to the above-mentioned configuration, in the event that the battery cell(s) 122 has (have) ignited, the fire-extinguishing agents 114, 116 become easily exposed to the flames and thereby can rapidly exhibit the negative-catalyst effect. In the event that the battery cell(s) 122 has (have) been subject to inappropriate handling and consequently has (have) ignited, the fire can be rapidly extinguished.

In one or more embodiments, the fire-extinguishing agents 114, 116 are disposed opposing the positive electrodes 122a of the battery cells 122.

With regard to the specific type of battery cells 122 (for example, lithium-ion battery cells), in the event that the battery cell(s) 122 ignite(s), flames extend from the positive electrode(s) 122a. According to the above-mentioned configuration, in the event that the battery cell(s) 122 of such a type has (have) ignited, the fire-extinguishing agents 114, 116 become easily exposed to the flames and thereby can rapidly exhibit the negative-catalyst effect. In the event that the battery cell(s) 122 has (have) been subject to inappropriate handling and consequently has (have) ignited, the fire can be rapidly extinguished.

In one or more embodiments, the battery pack 102 further comprises: the cell holder 124, which is housed in the casing 108 and holds the battery cells 122; and the control circuit board 112 (example of a circuit board), which is housed in the casing 108 and is mounted on the cell holder 124. The fire-extinguishing agents 114, 116, 118, 120 comprise the fire-extinguishing agents 120 (examples of a second fire-extinguishing agent), which are disposed between the control circuit board 112 and the cell holder 124.

According to the above-mentioned configuration, the space between the cell holder 124 and the control circuit board 112 can be effectively utilized.

In one or more embodiments, the battery cells 122 are lithium-ion battery cells.

The risk that a lithium-ion battery cell will ignite, owing to a variety of causes, is higher than in other types of battery cells. According to the above-mentioned configuration, even in the situation in which the lithium-ion battery cells have ignited, the fire can be rapidly extinguished.

1. A battery apparatus configured to supply electric power to an electric work machine, comprising:
one or more battery cells;
one or more fire-extinguishing agents, which include(s) a component that provides a negative-catalyst effect with respect to combustion; and
a casing, which houses the battery cell(s) and the fire-extinguishing agent(s).

2. The battery apparatus according to claim 1, wherein the one or more battery cells is (are) charged to a state of charge of 90% or more.

3. The battery apparatus according to claim 1, wherein the one or more battery cells (each) has an energy density of 300 Wh/liter or more.

4. The battery apparatus according to claim 1, further comprising one or more protective members, which cover(s) at least a portion of the one or more fire-extinguishing agents.

5. The battery apparatus according to claim 1, wherein the one or more battery cells comprise(s) five or more cylindrical-shaped battery cells.

6. The battery apparatus according to claim 1, wherein:
the casing has a chamber, which houses the one or more battery cells and the one or more fire-extinguishing agents; and
the chamber is sealed.

7. The battery apparatus according to claim 1, wherein the one or more fire-extinguishing agents comprise(s) a first fire-extinguishing agent, which is disposed opposing the electrode(s) of the one or more battery cells.

8. The battery apparatus according to claim 7, wherein the first fire-extinguishing agent is disposed opposing the positive electrode(s) of the one or more battery cells.

9. The battery apparatus according to claim 1, further comprising:
one or more cell holders, which is (are) housed in the casing and hold(s) the one or more battery cells; and
a circuit board, which is housed in the casing and is mounted on the one or more cell holders;
wherein the one or more fire-extinguishing agents comprise(s) a second fire-extinguishing agent, which is disposed between the circuit board and the one or more cell holders.

10. The battery apparatus according to claim 1, wherein the one or more battery cells comprise(s) one or more lithium-ion battery cells.

11. The battery apparatus according to claim 2, wherein the one or more battery cells (each) has an energy density of 300 Wh/liter or more.

12. The battery apparatus according to claim 11, further comprising one or more protective members, which cover(s) at least a portion of the one or more fire-extinguishing agents.

13. The battery apparatus according to claim 12, wherein the one or more battery cells comprise(s) five or more cylindrical-shaped battery cells.

14. The battery apparatus according to claim 13, wherein:
the casing has a chamber, which houses the one or more battery cells and the one or more fire-extinguishing agents; and
the chamber is sealed.

15. The battery apparatus according to claim 14, wherein the one or more fire-extinguishing agents comprise(s) a first fire-extinguishing agent, which is disposed opposing the electrode(s) of the one or more battery cells.

16. The battery apparatus according to claim 15, wherein the first fire-extinguishing agent is disposed opposing the positive electrode(s) of the one or more battery cells.

17. The battery apparatus according to claim 16, further comprising:
one or more cell holders, which is (are) housed in the casing and hold(s) the one or more battery cells; and
a circuit board, which is housed in the casing and is mounted on the one or more cell holders;
wherein the one or more fire-extinguishing agents comprise(s) a second fire-extinguishing agent, which is disposed between the circuit board and the one or more cell holders.

18. The battery apparatus according to claim 17, wherein the one or more battery cells comprise(s) one or more lithium-ion battery cells.
